(19) United States
(12) Patent Application Publication
(10) Pub. No.: US 2008/0036454 A1
(43) Pub. Date: Feb. 14, 2008

(54) Multi-Revolution Absolute High-Resolution Rotation Measurement System And Bearing Equipped With Such A System

(75) Inventor: Franck Landrieve, Fondettes (FR)

Correspondence Address: MEYERTONS, HOOD, KIVLIN, KOWERT & GOETZEL, P.C., P.O. BOX 398, AUSTIN, TX, 78767-0398, US

(73) Assignee: AKTIEBOLAGET SKF, Goteborg (SE)

(21) Appl. No.: 10/536,105

(22) PCT Filed: Oct. 8, 2004
(86) PCT No.: PCT/FR04/02542

§ 371 Date: Sep. 5, 2007

(30) Foreign Application Priority Data
Oct. 22, 2003 (FR) 03/12354

(51) Int. Cl. G01B 7/30

(52) U.S. Cl. 324/207.25

(57) ABSTRACT

A rotation measurement system comprises a rotatable annular magnetic encoder 16 carrying a series of encoding elements 23 arranged around the circumference of the encoder according to a periodic pattern, characterized in that it comprises a primary sensor assembly 38 comprising at least a primary magnetic sensor 38 disposed facing the encoding elements for detecting the angular position of the encoder with a discrete angular resolution of a fraction of a revolution equal to or less than one period of the encoder and an electronic counter for the number of fractions of a revolution made, and a secondary sensor assembly comprising secondary magnetic sensors 24a to 24d, 25a to 25d disposed facing the encoding elements for determining an absolute position of the encoder between two positions separated by at least one fraction of a revolution.

### BACKGROUND OF THE INVENTION

1. Field of the Invention

The present invention relates to the field of multi-revolution sensors, with electronic counter and storage, capable of supplying an output signal that is representative of the absolute position of a rotatable part. Such sensors can be used in order to supply, for example, the position of a linear jack comprising a rotatable electrical machine.

2. Description of the Relevant Art

A known solution is to make use of a mechanical assembly in order to count and store the number of revolutions effected by an encoder while another part of the system supplies the absolute position within one revolution. Thus, the number of revolutions is taken into account, even in the absence of electrical power. The electronic processing devices are informed of the exact position of the encoder when the power is restored. However, the mechanical assembly is relatively bulky and costly.

Furthermore, current instrumented bearings based on magnetic, capacitive or inductive phenomena cannot operate without an external supply of power, in the form of an electrical voltage, and perform an angular measurement and not a multi-revolution measurement.

The abstract of the document JP A 09-273943 describes an absolute multi-revolution encoder, comprising a rotatable part equipped with two optical paths and with two magnetic paths and a non-rotatable part comprising two optical sensors and two magnetic sensors, electronic circuits and a reserve power supply for powering the magnetic sensors. The electronic circuits offer a high power consumption mode and a low power consumption mode depending on whether a main power supply is active or not.

However, such a system is particularly complex, bulky and costly. The use of optical encoders is not desirable in some applications.

### SUMMARY OF THE INVENTION

One aim of the invention is to provide a compact, very robust rotation measurement system supplying absolute positional information over several revolutions with a high resolution at a reasonable cost.

Such a rotation measurement system comprises a rotatable annular magnetic encoder carrying a series of encoding elements arranged around the circumference of the encoder according to a periodic pattern, a primary sensor assembly comprising at least a primary magnetic sensor disposed facing the encoding elements for detecting the angular position of the encoder with a discrete angular resolution, of a fraction of a revolution equal to or less than one period of the encoder, and an electronic counter for the number of fractions of a revolution made, and a secondary sensor assembly comprising secondary magnetic sensors disposed facing the encoding elements for determining an absolute position of the encoder between two positions separated by at least one fraction of a revolution.

By detection of a position with a ‘discrete’ angular resolution is understood a determination of a position of the encoder from amongst a limited number of positions of the encoder within one revolution.

The secondary sensor assembly carries out a precise absolute detection over a fraction of a revolution and supplies information on the position of the encoder within a fraction of a revolution. The primary sensor assembly and the counter carry out a rotation detection with a low resolution but over several revolutions, and supplies information on the number of fractions of a revolution performed. Both pieces of information are combined, the system as a whole allowing information on the precise absolute position over several revolutions to be obtained. The primary and secondary sensor assemblies are equipped with magnetic sensors using the same encoding elements. The measurement system is thus robust and compact.

Advantageously, the system comprises main power supply means for the primary and secondary sensor assemblies, and temporary power supply means for the primary sensor assembly such that only the said primary sensor assembly is kept operational in case of a main power supply failure.

Accordingly, a detection over several revolutions, of lower resolution, can be maintained in the case of interruption of the main power supply, with an extended stand-alone capability owing to the fact that the resolution of the primary sensor assembly is low and that primary magnetic sensors with low power consumption can be employed. When the main power supply is restored, the primary and secondary sensor assemblies are again operational.

A temporary power supply means can comprise a capacitor of high capacitance, a battery and/or a cell. The choice of the type of power supply means may be made depending on the electrical power to be supplied and environmental constraints, such as temperature, impacts or pollution.

In one embodiment, the secondary sensor assembly comprises at least two encoders angularly separated by a non-integer number of periods and an interpolator capable of determining an absolute position of the encoder between two positions separated by a period by comparison of the signals from the two sensors.

In one embodiment, the secondary sensor assembly comprises at least a first group of sensors and a second group of sensors, the sensors of one group being situated facing the encoding elements while being angularly separated one relative to another by an integer number of periods, the sensors of one group being angularly separated by a non-integer number of periods relative to the sensors of the other group.

The encoding elements are preferably regularly spaced out such that the secondary sensors emit sinusoidal measurement signals.

A group of sensors disposed at various locations on the circumference of a periodic encoder, but simultaneously measuring the same quantity, allows the measurements from the various sensors to be used in order to compensate for dispersions in the manufacture of the encoder and/or of the sensor assembly, for geometrical defects of the encoder and/or of the sensor assembly, or for defects of coaxiality in their rotational alignment. The measurement precision is improved.

The two groups of sensors separated by a non-integer number of periods of the encoder allows measurement signals that are shifted as a function of the rotation of the encoder to be obtained. The comparison of the shifted signals allows the precision of encoder rotation measurements to be increased by means of the interpolator.

In addition, given the periodicity of the encoder, the interpolator performs an interpolation of the motion of the encoder, not over one encoder revolution, but over each fraction of a revolution corresponding to one period of the encoder. The angular position of the encoder is known with greater precision.

Furthermore, since the encoder comprises an increased number of magnetic poles, the magnetic field sensed by the sensors from each pole is weaker, but, whatever the magnetic profile of the poles, the greater the distance between the poles and the sensors, the more a signal sensed by the sensors corresponds to a sinusoid, a fact which improves the precision of the measurements in the case of an interpolator based on sinusoidal functions.

The second sensor group may advantageously be separated from the first group of sensors by a quarter of a period in order to obtain signals in quadrature.

One group of sensors comprising two diametrically opposing sensors allows coaxiality or rotational alignment defects to be corrected effectively.

The system can comprise means for adding together the signals originating from the sensors of one group into one resultant signal to be used as input to the interpolator.

Advantageously, the primary sensor assembly comprises at least one passive sensor, and preferably at least two passive sensors, such as for example a reed relay switch and/or a sensor of the Wiegand wire type.

By passive sensor will be understood a sensor that does not require an electrical power supply in order to modify its output state. Using a passive auxiliary sensor, consuming little or no electrical power, is particularly advantageous for increasing the stand-alone capability of the system. In addition, a sensor of the type proposed is capable of detecting low speed rotations, which case often occurs when a rotatable element is rotated with no electrical power, for example manually.

In one embodiment, a periodic pattern is repeated circumferentially on the encoder at least twice.

The resolution of the primary sensor assembly can be finer than one period of the encoder, and for example equal to a half-period or a quarter of a period. Preferably, the resolution is at most equal to a quarter of a period.

The invention also relates to an instrumented bearing comprising an outer ring, an inner ring and at least one row of rolling elements, and a rotation measurement system according to one aspect of the invention.

### BRIEF DESCRIPTION OF THE DRAWINGS

The present invention will be better understood and other advantages will become apparent upon reading the detailed description of a few embodiments, taken as non-limiting examples, that are illustrated by the appended drawings, in which:

FIG. 1 is an axial cross-sectional view of a bearing unit equipped with a rotation measurement system according to one aspect of the invention;

FIG. 2 is a front view in elevation of an encoder and of the sensor assembly of a measurement system according to a first embodiment;

FIG. 3 is an axial cross-sectional view corresponding to FIG. 2;

FIG. 4 is a schematic view of a processing unit of a measurement system according to FIGS. 2 and 3;

FIG. 5 is a schematic view of an electronic module for the measurement system in FIG. 1 to 4;

FIG. 6 is a schematic view of an electronic module of a measurement system according to a variant of the module in FIG. 5.

### DETAILED DESCRIPTION OF THE PREFERRED EMBODIMENTS

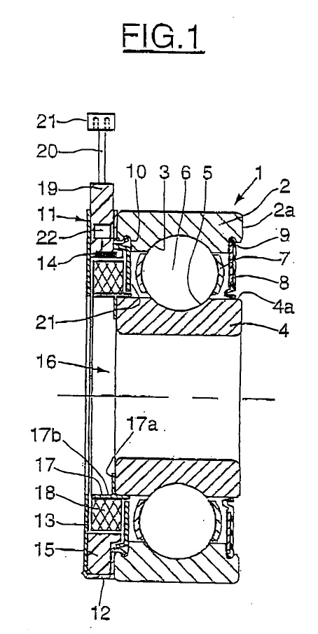

As can be seen in FIG. 1, a bearing unit 1 comprises an outer ring 2 with a bearing channel 3, an inner ring 4 with a bearing channel 5, a set of rolling elements 6, here ball-bearings, disposed between the bearing channels 3 and 5, a cage 7 for maintaining the circumferential spacing of the rolling elements 6, and a sealing gasket 8 mounted on the outer ring 2 and coming into frictional contact with a cylindrical holder 4a on the inner ring 4, while being disposed radially between the two rings 2 and 4 and axially between the set of rolling elements 6 and one of the lateral surfaces of the rings 2, 4. The sealing gasket 8 is mounted in an annular groove 9 formed in the outer ring 2, close to its radial lateral surface 2a. The outer ring 2 also has a groove 10 on the opposite side, symmetrical to the groove 9, with respect to a plane passing through the centre of the rolling elements 6.

A sensor block, referenced 11 as a whole, is mounted on the outer ring 2 on the side of the groove 10. The sensor block 11 comprises a metal support 12, a metal cover 13 and sensor elements 14, only one of which is visible in FIG. 1, embedded in a central part made of synthetic material 15.

The metal support 12, of generally annular shape, is hooked into the groove 10 and surrounds radially the central part 15 and the metal cover 13, which is generally disc-shaped. The central part 15 is bounded radially by the support 12 towards the outside and has a hole 15a, of diameter such that a large enough radial space remains for the encoder, which will be described later. The sensor elements 14, fixed onto the central part 15, are flush with the hole 15a. One end of the central part 15, radially protruding towards the outside, forms an output terminal 19 for the wire 20. The terminal 19 passes through a notch formed in the support 12. The wire 20 is connected to a connector 21, which can be connected to a complementary connector, not shown, for the electrical power supply and for the transmission of information.

The encoder 16 comprises an annular support 17 and an active part 18. The support 17 is of annular shape with a ‘T’ cross section and comprises a radial portion 17a in axial contact with a radial front surface 4b of the inner ring 4, on the same side as the sensor block 11, and a cylindrical portion 17b running from the outer edge of the radial portion 17a, axially from the two sides, being push-fitted on the side of the inner ring 4 onto a cylindrical holder 4c of the inner ring 4. The, holder 4c is preferably symmetric to the holder 4a with respect to a radial plane passing through the centre of the rolling elements 6.

The active part 18 of the encoder 16 is of annular shape and of generally rectangular cross section disposed on the outer rim of the cylindrical portion 17b. The active part 18 runs axially in the direction of the rolling elements 6, beyond the radial portion 17a, between the outer 2 and inner 4 rings, substantially as far as the level of the groove 10 of the outer ring 2.

The active part 18 extends up to the neighbourhood of the hole 15a in the central part 15 with which it forms a radial air-gap. When the inner ring 4 rotates, relative to the outer ring 2, the active part 18 of the encoder 16 passes in rotation in front of the sensor elements 14, which are capable of delivering an electrical signal at the output. The active part 18 of the encoder 16 is a multi-polar magnetized ring, for example made of plasto-ferrite. The encoder 16 and the sensor block 11 form a rotation parameter detector assembly.

The sensor block 11 also comprises an electronic module 22 embedded in the central part 15 and connected, on the one hand, to the sensor elements 14 and, on the other, to the connector 21 by means of the wire 20. The electronic module 22 carries means for processing the signals emitted by the sensor elements.

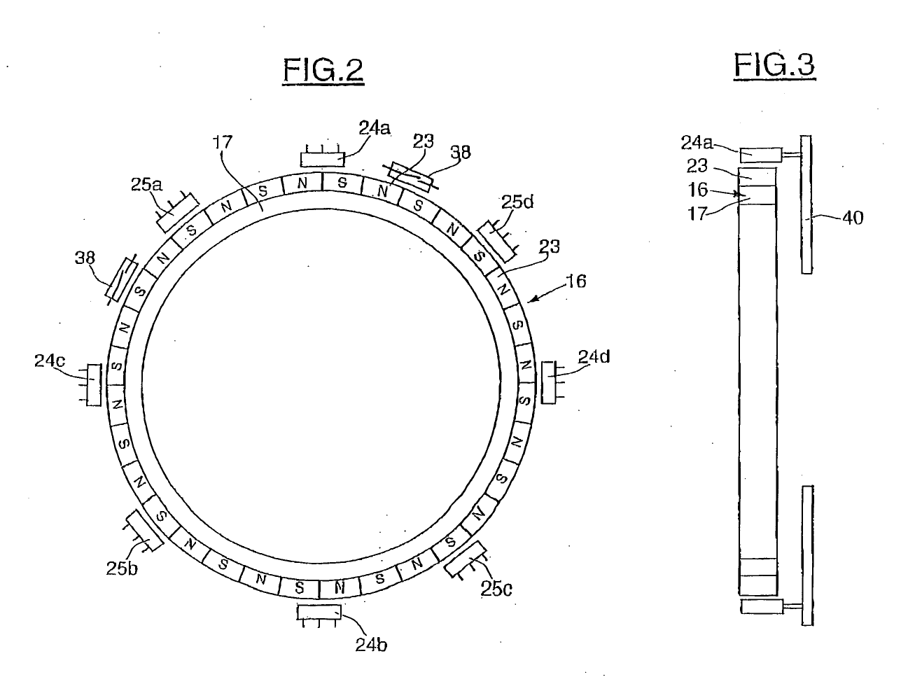

In FIGS. 2 and 3, where the references for the elements similar to those in FIG. 1 have been conserved, an encoder 16 comprises an annular support 17 carrying on its outer periphery an active region composed of encoding elements 23, here in the form of a regular alternation of magnetic poles of opposite polarity, ‘north’ (N) and ‘south’ (S), on the circumference of the encoder 16, thus forming a periodic pattern composed of a ‘north’ pole and a ‘south’ pole repeated an integer number of times around the circumference of the encoder, here sixteen times. Each periodic pattern therefore covers a fraction of one sixteenth of a revolution corresponding to an angle of 22.5°.

A secondary sensor assembly comprises a plurality of secondary sensors disposed radially facing the active region of the encoder 16. The sensor assembly comprises two groups of sensors. Each group of sensors comprises a plurality of sensors, here four, angularly separated by an integer number of periods of the encoder. Thus, when the encoder passes in front of the sensors, the sensors of the same group simultaneously see the same pattern and emit identical signals.

The sensors of one group of sensors are, on the other hand, angularly displaced by a non-integer number of periods relative to the sensors of the other group. The two groups here are mutually displaced by a quarter of a period.

In view of the regular alternation of ‘north’ and ‘south’ poles, the secondary sensors will emit sinusoidal signals as a function of the angular position of the encoder. In view of the mutual displacement of a quarter of a period, the signals from the sensors of a group will be in quadrature with the signals from the sensors of the other group. In view of the periodicity of the encoder, the signals from the sensors will describe a complete sine wave when the encoder moves by a fraction of a revolution corresponding to the period of the encoder and will subsequently be repeated for each period or fraction of a revolution.

More precisely, the first group of sensors 24a, 24b, 24c, 24d comprises four sensors equidistantly distributed on the periphery of the encoder such that any sensor 24a, 24b, 24c, 24d is angularly separated from the next by 90°. The first group of sensors therefore comprises two pairs of diametrically opposing sensors 24a, 24c and 24b, 24d, the pairs being separated by 90°.

The sensors 25a, 25b, 25c, 25d of the second group of sensors are distributed in a similar manner, being separated by 39.375° in the anti-clockwise direction relative to the sensors 24a, 24b, 24c, 24d of the first group.

As is shown in FIG. 2, the sensors 24a, 24b, 24c, 24d of the first group are situated straddling a region of ‘north’ polarity and a region of ‘south’ polarity, and the sensors 25a, 25b, 25c, 25d of the second group of sensors are at the centre of regions of ‘south’ polarity, which indeed corresponds to a separation of a quarter of a period.

The measurement system additionally comprises a primary sensor assembly comprising two sensors 38 of the Wiegand wire type, which comprise a coil disposed around a Wiegand wire generating an electrical pulse when the surrounding magnetic field changes polarity. The sensors 38 therefore detect a succession of fields which are reversed at each step. This sensor device does not draw any current. The primary sensors 38 are angularly separated from one another by a non-integer number of periods, here a quarter of a period. As can be seen in FIG. 2, one of the primary sensors 38 is disposed at the centre of a magnetized region of south polarity ‘S’, whereas the other primary sensor 38 is disposed straddling a magnetized region of north polarity ‘N’ and a magnetized region of south polarity ‘S’.

As a variant, the primary sensors 38 are reed relay switches. This type of sensor is activated by the magnetic field and does not therefore itself draw any current.

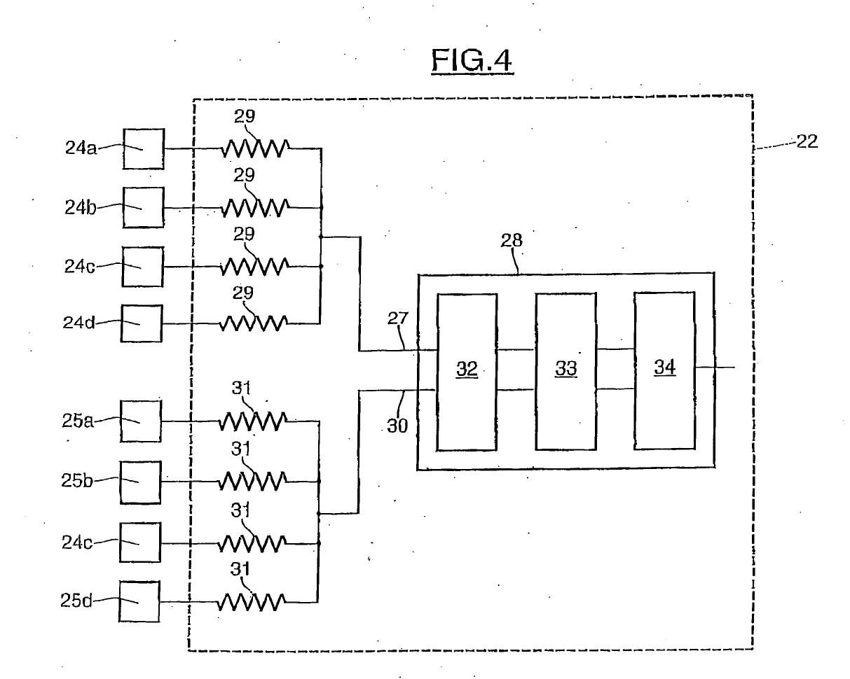

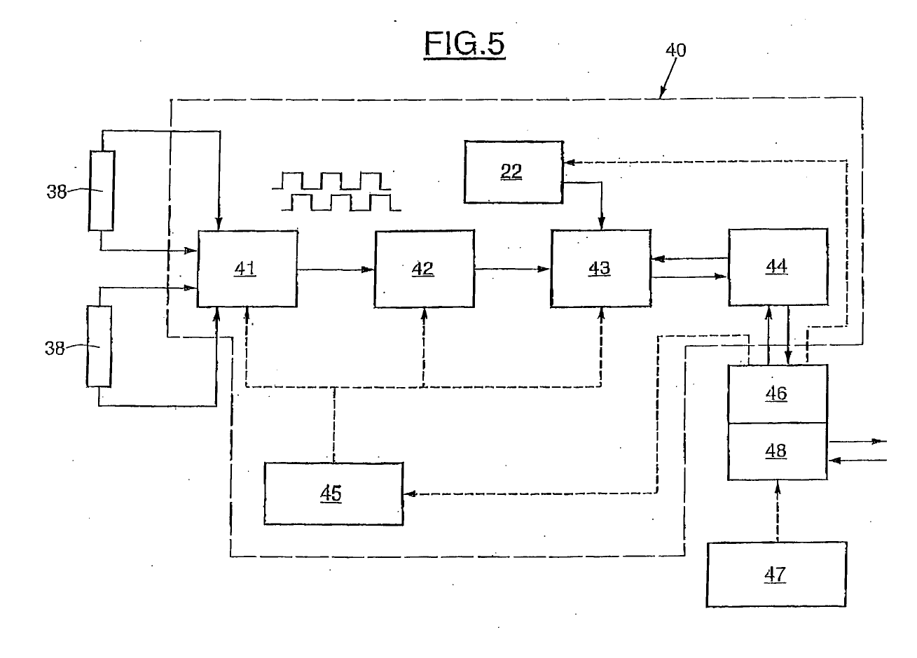

In FIG. 3, the measurement system comprises an electronic module 40 carrying the sensors, only two 24a, 24c being visible in FIG. 3. The electronic module associated with the primary and secondary sensor assemblies is illustrated in more detail in FIGS. 4 and 5.

In FIG. 4, a processing unit 22 of the electronic module is illustrated that is dedicated to the processing of the signals from the secondary sensors.

The outputs of the sensors 24a, 24b, 24c, 24d of the first group are connected in parallel to a first input 27 of a processing module 28, each output being connected to the input via a resistor 29. The resistors 29 all have the same value. In this way, the output signals from the sensors 24a, 24b, 24c, 24d are added into a first resultant signal that is the arithmetic mean of the output signals from the sensors 24a, 24b, 24c, 24d of the first group.

Similarly, the outputs of the sensors 25a, 25b, 25c, 25d of the second group are connected in parallel to a second input 30 of the processing unit 28, each output being connected to the input 30 via a resistor 31, the resistors 31 having the same value as the resistors 29 associated with the first group of sensors. The second resultant signal of the second input is the arithmetic mean of the output signals from the sensors of the second group.

The array of resistors 29 and 31 allows the signals emitted by the sensors of the same group to be averaged in order to form resultant signals compensating for the various defects, such as eccentricity defects of the encoder, local magnetization defects of the encoder, or positioning defects of the sensors. Given that the signals are averaged, an interpolator designed to operate with one sensor can be used without changing the parameters of this interpolator.

The processing module 28 comprises a filter stage 32, an analogue/digital converter stage 33 and an interpolation stage 34 or interpolator.

The stages are installed in series. The first and second inputs 27, 30 are connected to the filter stage 32. The converter stage 33 is installed downstream of the filter stage 32 and performs a conversion of the first and second filtered analogue resultant signals into digital signals. The interpolation stage 34 is disposed downstream of the converter stage 33 and has two inputs and an output.

The interpolation stage 34 receives the first and second digitized resultant signals and determines a signal that is representative of the position of the encoder 16. The quadrature sinusoidal signals from the secondary sensors correspond to a sine and a cosine. The interpolator applies the arctangent function to the ratio of the sine over the cosine and determines a single corresponding value of absolute position of the encoder. Since the sinusoidal signals from the sensors describe a sinusoidal period each time that the encoder 16 moves by a fraction of a revolution corresponding to one period of the encoder 16 which are subsequently repeated, the interpolation only allows the absolute position of the encoder 16 to be known between two successive positions of the encoder 16 separated by a fraction of a revolution corresponding to one period of the encoder 16, but with an improved precision since, for a given small movement of the encoder, the intensity variations of the measurement signals are large, which allows the precision of the interpolation calculation and, ultimately, the precision of the measurements of the small movements to be improved.

In FIG. 5, the electronic module 40 comprises the processing unit 22, a filter element 41, a processing element 42, an electronic counter 43, an interface 44, a temporary power supply 45 and an unpluggable connector 46.

Flows of supply in electrical power are represented by dashed arrows. The connector 46 is connected by power supply links to the temporary power supply 45, to the interface 44 and to the processing unit 22 for their power supply and/or recharge. The temporary power supply 45, in the form of discrete elements, comprises a battery and/or a capacitor of high capacitance, for example 10 Farad, and supplies the filter element 41, the processing element 42 and the counter 43. A main power supply 47 is connected in an unpluggable manner to the connector 46 by a complementary connector 48. The main power supply 47 allows the temporary power supply 45 to be recharged when the connectors 46 and 48 are plugged together.

Data transmission flows are shown by solid line arrows. The processing unit 22 is connected to the secondary sensors 24a to 24d and 25a to 25d (FIG. 4) of the first and second groups of sensors. The filter element 41 is connected to the sensors 38. The processing element 42 is installed downstream of the filter element 41 and receives one or more signals, preferably digital, from the said filter element 41, the filter element 41 being capable of providing a pre-processing operation comprising a digitization step. As illustrated in FIG. 5, the processing element 41 here delivers squarewave signals indicating a change of polarity in front of the sensors, and therefore indicating the movement of the encoder by a fraction of a revolution corresponding to a half-period of the encoder. The resolution of the primary sensor assembly is here equal to a half-period of the encoder.

The counter 43 is installed downstream of the processing element 42 and receives from the said processing element 42 an incrementation or decrementation signal indicating that the encoder has advanced or reversed by one revolution increment equal to a fraction of a revolution corresponding to one period of the encoder. The counter 43 also receives an output signal from the processing unit 22 which is directly a value of the absolute position of the encoder within a fraction of a revolution corresponding to one period of the encoder, the said position being supplied by the interpolator 34 (FIG. 4). The counter 43 combines the information on the number of fractions of a revolution travelled, supplied by the primary sensor assembly 31, 41, 42, and the information on the absolute position of the encoder between two angular positions separated by one period in order to encode the multi-revolution absolute position of the encoder over n bits.

The interface 45 is installed downstream of the auxiliary counter 43 and receives the position signal encoded over n bits. The connector 46 is designed for the transmission of power and also for the transmission of data. The interface 45 is connected to the connector 46 for the transmission of the position information to external devices via the connector 48.

Data streams can also come from external devices. Data or commands can be transmitted from the outside via the connectors 48, 46 towards the interface 44, and from the interface towards the counter 43 or the processing unit 22. These data can be control data, such as initialization or reset data for the counter 43 and for the processing unit. This can be useful when the measurement system is installed. In this case, a mobile element equipped with the encoder can be disposed in a reference position, then the counter 43 and the processing unit 22 initialized. This reference position will correspond to the zero of the measurement system. The reference position can be an end position at a travel limit and the encoder will subsequently indicate a positive position within a range of movement of the mobile element. The reference position can also be an intermediate position, for example in the mid-range, and the measurement system will indicate a positive or negative position measurement depending on the position of the mobile element relative to the reference position.

Advantageously, the electronic module 40 is formed from a custom-designed circuit, for example an ASIC, and is of the very low consumption type, for example less than 10 □A. The electronic module 40 can also be formed from different components performing the analogue and logic operations, from a programmable analogue circuit, for example an EPLD, from a micro-controller or from discrete components.

The processing element 42 is capable of determining the direction of rotation from the quadrature of the signals from the two primary sensors 38. It will be noted that the processing element 42 processing squarewave signals may be formed simply by discrete logic elements of the AND/OR logic gate type.

The temporary power supply 45 can also comprise a cell which could be disconnected when the main power supply 47 is connected to the electronic module 40.

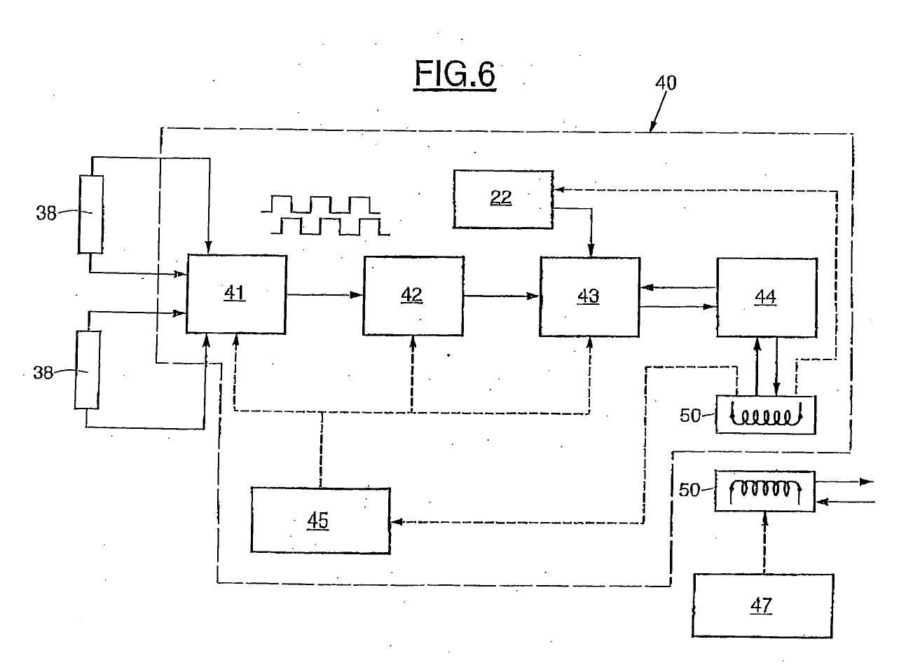

The variant illustrated in FIG. 6 differs from FIG. 5 in that the connectors are replaced by a remote transmission element 50, for example having a resonating circuit, and a complementary distant element 51. The element 50 can form a part of the electronic module 40, or be connected to the electronic module 40. The resonating circuit allows electrical power and also data to be transmitted.

The embodiment illustrated hereinabove allows the number of fractions of a revolution effected by the encoder to be determined by means of the primary sensor assembly, with a resolution of a half-period, by using passive sensors using little or no electrical power.

In the case of an interruption of the main power supply, the interface 44, the temporary power supply 45 and the processing unit 22 are no longer powered. The temporary power supply 45 maintains a supply that is sufficient for the operation of the filter 41 and processing 42 elements and of the counter 43. An auxiliary sensor assembly is thus kept active and continues to detect the position of the encoder to the nearest fraction of a revolution. The auxiliary sensor assembly, with low-power-consumption electronic elements and passive sensors consuming little or no power has a significant stand-alone capability.

The processing unit 22 remains inactive in the case of an interruption of the power supply. When power is restored, the temporary supply means 45 are put back into charge and power is restored to the interface 44 and the processing unit 22. The absolute position supplied by the interpolator of the processing unit 22 can be added to the position determined by the electronic counter 43 which remained active during the main power interruption; this allows the encoder absolute position to be known once again with a high precision relative to an initial reference position.

The measurement systems illustrated in FIGS. 2 to 7 can be associated with a bearing unit, as illustrated by FIG. 1, but may also be envisaged independently of a bearing unit.

The encoder will advantageously be a multipolar magnetic pulse ring, formed from magnets or else magnetized plasto-ferrite or elasto-ferrite and used, for example, with inductive sensors or a toothed wheel used, for example, with Hall-effect sensors.

The number of periods of the sensor is chosen, on the one hand, as a function of a primary sensor precision and, on the other, as a function of a desired precision. This means that, with low-precision sensors, and especially in the case of passive sensors, it is preferable to provide alternating poles with a spacing that is large enough for a change of polarity to modify the state of the sensor. Furthermore, when the number of periods is increased, the precision of the measurement of the absolute position of the encoder can be increased by means of a secondary sensor assembly, notably with a secondary sensor assembly comprising at least two mutually-displaced sensors and an interpolator.

Thanks to the invention, a rotation measurement system is available that allows the measurement precision obtained to be improved, notably by the use of an interpolator, and defects of the measurement system to be compensated for and the precision of the measurements thus to be improved. In addition, the measurement system can supply precise rotation information over several revolutions, and the system is designed to remain partially active in the absence of external electrical power supply, with a significant stand-alone capability and with recovery of precise absolute position information when the external electrical power supply is restored.

1. Rotation measurement system, comprising:
a rotatable annular magnetic encoder carrying a series of encoding elements arranged around the circumference of the encoder according to a periodic pattern;
a primary sensor assembly comprising at least a primary magnetic sensor disposed facing the encoding elements for detecting the angular position of the encoder with a discrete angular resolution of a fraction of a revolution equal to or less than one period of the encoder and an electronic counter for the number of fractions of a revolution made; and
a secondary sensor assembly comprising secondary magnetic sensors disposed facing the encoding elements for determining an absolute position of the encoder between two positions separated by at least one fraction of a revolution.

2. System according to claim 1, further comprising main power supply means for the primary and secondary sensor assemblies, and temporary power supply means for the primary sensor assembly such that the said primary sensor assembly is kept operational in case of a main power supply failure.

3. System according to claim 2, wherein the temporary power supply means comprises a capacitor of high capacitance, a battery and/or a cell.

4. System according to claim 1, wherein the periodic pattern is repeated circumferentially at least twice on the encoder.

5. System according to claim 1, wherein the secondary sensor assembly comprises at least two sensors angularly separated by a non-integer number of periods and an interpolator capable of determining an absolute position of the encoder by comparison of the signals from the two sensors.

6. System according to claim 5, wherein the secondary sensor assembly comprises at least a first group of sensors and a second group of sensors, the sensors of one group being situated facing the encoding elements while being angularly separated one relative to another by an integer number of periods, the sensors of one group being angularly separated by a non-integer number of periods relative to the sensors of the group.

7. System according to claim 6, further comprising a second group separated from the first group by a quarter of a period.

8. System according to claim 6, further comprising means for adding together the measurement signals originating from the sensors of one group into a resultant single signal.

9. System according to claim 1, wherein the primary sensor assembly comprises a passive sensor, and preferably at least two passive sensors.

10. System according to claim 9, wherein the primary sensor assembly comprises a reed relay switch and/or a sensor of the Wiegand wire type.

11. System according to claim 1, wherein the resolution of the primary sensor assembly is at most equal to a quarter of a period.

12. Instrumented bearing comprising an outer ring, an inner ring, at least one row of rolling elements, and a rotation measurement system according to claim 1.
